(19) United States
(12) Patent Application Publication
(10) Pub. No.: US 2004/0080658 A1
(43) Pub. Date: Apr. 29, 2004

(54) Low cost electronic camera made using integrated circuit technology

(76) Inventors: Pierre Cambou, Grenoble (FR); Gilles Simon, Le Fontanil (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/469,873

(22) PCT Filed: Mar. 15, 2002
(86) PCT No.: PCT/FR02/00936

(30) Foreign Application Priority Data
Mar. 16, 2001 (FR) 01/03626

(51) Int. Cl. H04N 5/225

(52) U.S. Cl. 348/340

(57) ABSTRACT

The invention relates to electronic cameras for visualization of light images. The camera (40) includes an electronic image sensor (42) having an active face (79) including an arrangement of photosensitive pixels forming a photosensitive surface (44), electrical conductors on the active face and a free face (102) on the opposite side from the active face, and an optics unit (46) including at least one lens (52) for focusing the light images on the photosensitive surface of the sensor. The optics unit of the camera is mechanically secured to the sensor and, in order to provide centered focusing of the light images on the photosensitive surface of the sensor, at least two positioning surfaces of the optics unit (72, 74) and of the sensor (79) are in direct mechanical contact.

Applications: low-cost electronic cameras for a microcomputer, portable telephones, photo-digital device.

The invention relates to a mass-produced electronic camera of small dimensions and with low cost, and in particular to the optical part for focusing the images on an electronic sensor made using integrated circuit technology.

Electronic cameras use an electronic image sensor (or electronic chip) instead of the silver film of traditional cameras. Electronic sensors, made using integrated circuit technology, take the form of electronic chips including an arrangement of pixels forming a photosensitive surface. The arrangement of photosensitive pixels provides electronic signals corresponding to the light image focused by the optics of the camera on the photosensitive surface of the sensor. Electronics for processing the signals generate an electronic signal corresponding to the real light image projected onto the photosensitive surface of the sensor. These types of sensors are used in low-cost imaging, for example in digital cameras, mass-market photo-digital devices.

The assembly of electronic cameras with small dimensions (of the order of 1 cm³) is currently carried out using conventional methods taken from photography.

FIG. 1 shows a simplified embodiment of a prior art electronic camera 10 including an electronic image sensor 12 made using integrated circuit technology and a lens 14 for focusing the images on a photosensitive surface 16 of the sensor. The image sensor is fixed on a printed circuit 18 secured to a housing 20 of the camera, a support 22 of the lens is fixed on the same printed circuit.

The structure of the prior art camera in FIG. 1 has drawbacks. Specifically, the dispersion of the tolerances in manufacture and mounting of the optical elements makes the positioning of the image projected by the lens onto the photosensitive surface of the sensor imprecise. Positioning adjustments of the lens with respect to the sensor prove necessary, and in particular adjustment of the focusing of the lens along the optical axis ZZ′, which has an impact on the mass production cost.

In the layout of FIG. 1, the lens 14 needs to be positioned, on the one hand, horizontally with respect of the surface so as to center the light images on all of the photosensitive surface of the sensor and, on the other hand, vertically along the optical axis ZZ′ in order to focus the image optimally on the sensitive surface. The lens 14 is secured to a thread ring 24 surrounding the lens, capable of being screwed into the support 22 which includes a screw thread complementary to the screw thread of the ring. The lens can then be moved along the optical axis ZZ′ in order to carry out focusing on the photosensitive surface of the sensor and to compensate for the variations of the tolerances in mounting and manufacture of the optics unit. Once the focusing adjustment has been carried out, the lens can be fixed in position, for example by adhesively bonding the ring 24 onto the support 22.

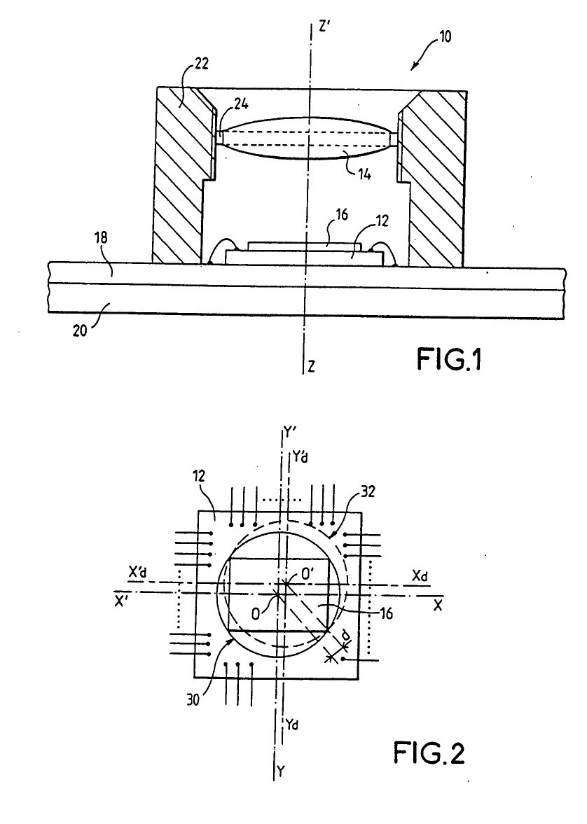

The optical structure in FIG. 1 has another drawback associated with the dispersions in positioning of the support 22 of the lens with respect to the photosensitive surface 16 of the sensor 12. FIG. 2 shows a defect in the centering of an image 30 on the photosensitive surface 16 of the sensor 12 of the camera in the figure. The theoretical center O of the image 30 lies at the intersection of the symmetry axes XX′ and YY′ of the photosensitive surface 16 of the sensor. A dispersion in horizontal positioning, along these axes XX′ and YY′, of the support of the lens with respect to the photosensitive surface of the sensor produces an image 32 whose center O′ is offset with respect of the theoretical center O. This dispersion in positioning of the support 22 with respect to the photosensitive surface of the sensor, which may be of the order of 300 micrometers, produces decentering of the image focused on the sensitive surface of the sensor, generating linearity and sensitivity defects especially at the corners of the image. Furthermore, some of the edges of the decentered image may be projected onto elements of the chip, or of the support of the lens, which produce parasitic reflections that reduce the contrast of the image.

In order to overcome the drawbacks of the prior art electronic cameras, the invention provides an electronic camera for visualization of light images, including an electronic image sensor having an active face including an arrangement of photosensitive pixels forming a photosensitive surface, electrical conductors on the active face and a free face on the opposite side from the active face, an optics unit including at least one lens for focusing the light images on the photosensitive surface of the sensor, characterized in that the optics unit is mechanically secured to the sensor and in that, in order to provide centered focusing of the light images on the photosensitive surface of the sensor, at least two positioning surfaces are in direct mechanical contact, one of the surfaces being on the optics unit and the other surface being on the sensor.

The mechanical positioning of the optics unit and of the electronic sensor, with respect to one another, is carried out by direct mechanical contact between two positioning surfaces, one on the optics unit and the other on the electronic sensor. These two positioning surfaces in direct mechanical contact determine with high precision the position of the optical axis ZZ′ and the distance of the focusing lens from the sensitive surface of the sensor.

In a first embodiment of the camera according to the invention, the optics unit and the electronic sensor each include three mutually perpendicular plane surfaces, a plane surface of the optics unit being in contact with a respective parallel plane surface of the electronic sensor, each pair of surfaces in contact canceling one of the three degrees of freedom of the optics unit with respect to the sensor at least in one of the two directions of each of the three axis of a reference trihedron Oxyz. This first embodiment of the invention provides focusing and precise centering, which is reproducible in terms of manufacture, of the light images on the photosensitive surface of the sensor.

In the preferred embodiments, which are suitable for very low-cost cameras, the focusing lens forms an integral part of the optics unit, making it directly secured to the sensor by means of the optics unit and the positioning surfaces.

In the various embodiments of the camera, the electronic sensor is placed on a printed circuit including electrical conductors joined to the electrical input/output ports of the sensor. The electrical connections between the sensor and the printed circuit may be produced according to various known techniques.

According to a first technique, the electronic sensor is placed via its free face on a printed circuit including electrical conductors, electrical connection wires joining the electrical conductors of the active face to the electrical conductors of the printed circuit. This connection, using connection wires, is commonly referred to as “bonding”

According to a second technique, the electronic sensor is placed via its active face on the printed circuit including an opening for light to pass onto the photosensitive surface of the sensor. The electrical connections are made by melting solder microbeads between the electronic sensor and the printed circuit. These beads are arranged level with the electrical connections of the electronic sensor, facing the electrical conductors of the printed circuit. This technique of mounting the electronic sensors, using solder microbeads, is commonly referred to as “flip chip”

The invention will be understood more clearly with the aid of exemplary embodiments of electronic cameras according to the invention.

FIG. 1 represents a partial view of a prior art electronic camera;

FIG. 2 shows a defect in the centering of an image on the photosensitive surface of the sensor of the camera in FIG. 1;

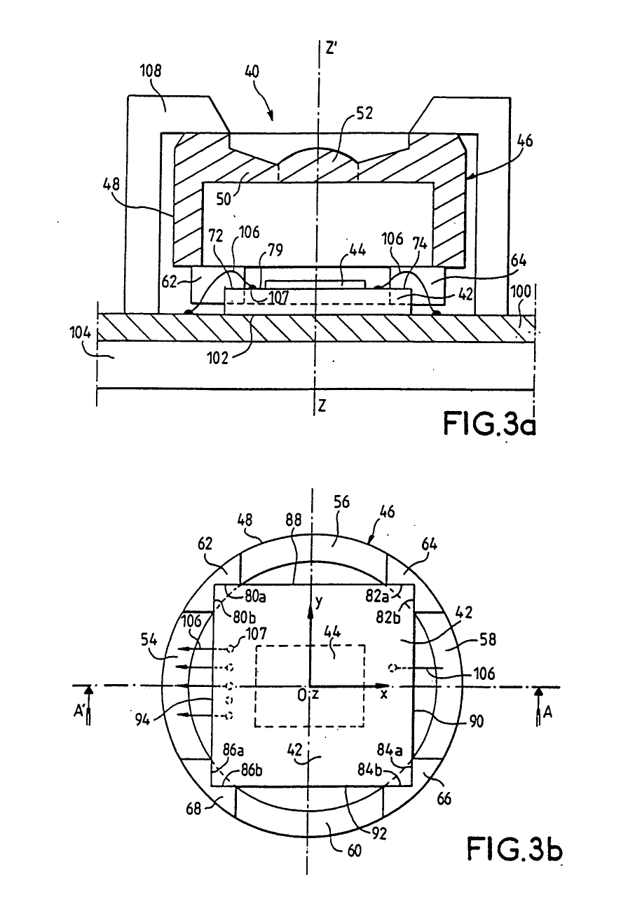

FIG. 3a shows a partial view in section of an electronic camera according to the invention;

FIG. 3b shows a view of the camera in FIG. 3a from below;

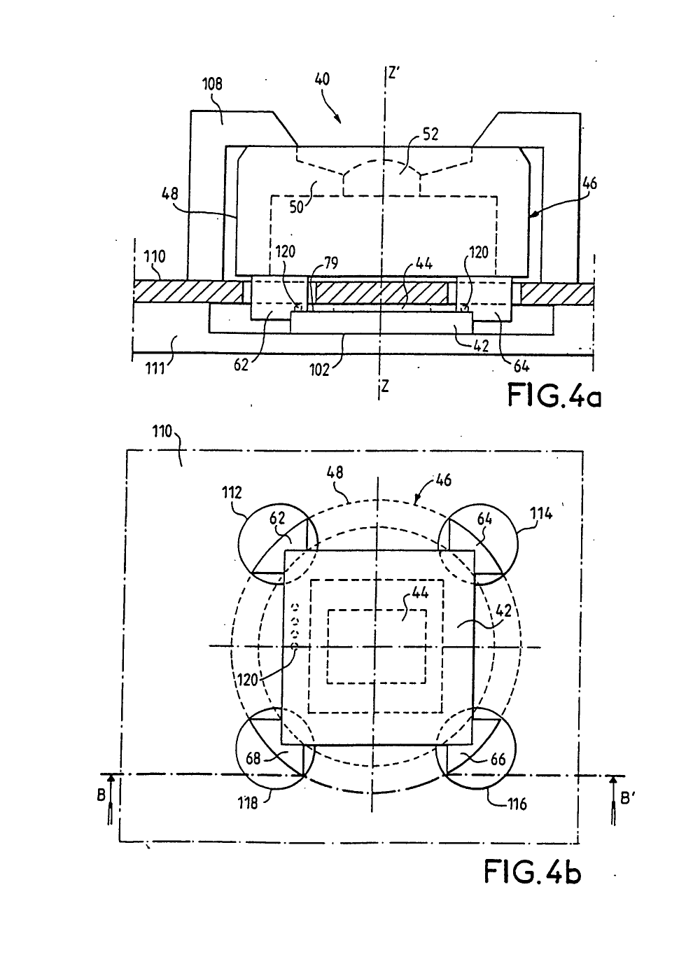

FIG. 4a shows a layout variant of the camera in FIG. 3a;

FIG. 4b shows a view of the camera in FIG. 4a from below;

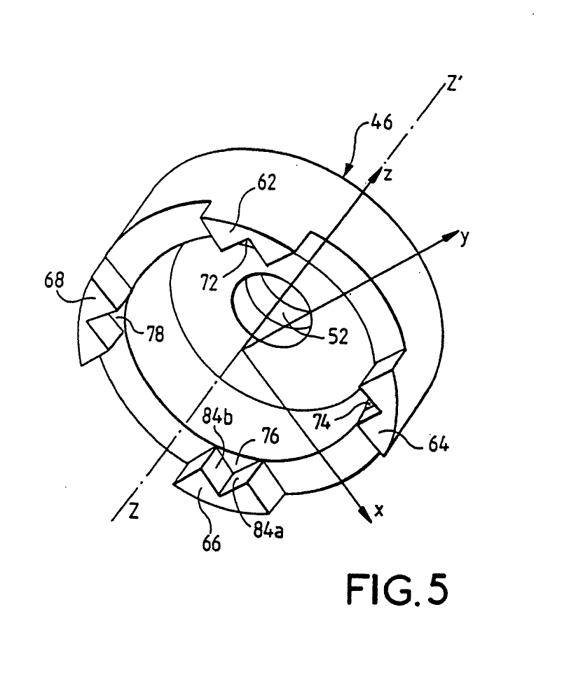

FIG. 5 represents a perspective view of an optics unit of the cameras in FIGS. 3a and 4a.

FIG. 3 shows a partial view in section on A′A of an electronic camera 40 according to the invention, and FIG. 3b shows a view of the camera in FIG. 3a from below.

The camera 40 includes an electronic image sensor 42 (or electronic chip) including an arrangement of photosensitive pixels forming a photosensitive surface 44, and an optics unit 46.

The optics unit 46, of cylindrical shape about an axis of revolution ZZ′, includes a first cylindrical wall 48 about the same axis ZZ′. The first cylindrical wall is closed in an upper part by a second wall 50 perpendicular to the axis ZZ′. The second wall 50 includes a lens 52 at its center for focusing the images on the photosensitive surface of the electronic sensor 42.

The lower part of the cylindrical wall 48 includes passages 54, 56, 58, 60 leaving feet 62, 64, 66, 68 exposed for fastening the electronic sensor 42 onto the optics unit 46 on the same side as its photosensitive surface 44. Each of the feet 62, 64, 66, 68 includes:

a horizontal surface 72, 74, 76, 78 parallel to the plane Oxy. The horizontal surfaces are in direct mechanical contact with an active face 79 of the electronic sensor 42 on the same side as the photosensitive surface 44, holding the focusing lens 52 in longitudinal position, along the axis ZZ′, with respect to the said photosensitive surface 44 of the sensor. Only a single tolerance associated with the manufacturing precision of the optics unit is hence involved in the vertical positioning, along the axis ZZ′, of the lens with respect to the photosensitive surface of the sensor.

a pair of vertical surfaces 80a and 80b, 82a and 82b, 84a and 84b, 86a and 86b which are parallel to the axis ZZ′. The vertical surfaces of one pair, which are mutually parallel and parallel to the horizontal surfaces 72, 74, 76, 78 of each of the feet, are in contact with vertical surfaces of the edges 88, 90, 92, 94 of the electronic sensor.

The vertical surfaces of the optics unit 46 and of the sensor 42 in mechanical contact hold the focusing lens 52 in horizontal position, in the plane Oxy, with respect to the photosensitive surface of the sensor. Only two tolerances, associated with the manufacturing precision of the optics unit and with the manufacturing precision of the sensor 42, are involved in the positioning of the focusing lens 52 with respect to the photosensitive surface 44 of the sensor.

The mechanical contacts between the various positioning surfaces of the optics unit and of the sensor may be obtained in a way which is known to the person skilled in the art of mechanics, by selection of the manufacturing tolerances of the optics unit and of the sensor. For example, these tolerances may be calculated so that the sensor is held between the feet of the optics unit, by clamping the sensor between the surfaces in contact, so as to obtain the desired positioning precision.

The sensor is placed on a printed circuit 100 via its free face 102, on the opposite side from its active face 79 including the photosensitive surface. The printed circuit is mechanically supported by a housing 104 of the camera.

Electrical connections 106 join electrical output points 107 (or metallic areas) of the electronic sensor and electrical conductors of the printed circuit producing the electrical connections between the sensor and electronics (not shown in the figures) for processing the signals of the pixels of the electronic camera.

The optics unit may furthermore be held in position along the axis ZZ′, in direct contact with the electronic sensor, with the aid of a holding piece 108 secured to the printed circuit 100, the holding piece exerting a force for holding the optics unit against the electronic sensor 42.

FIG. 4a shows a partial section on BB′ of an alternative embodiment of the camera in FIG. 3a, and FIG. 4b shows a view of the camera in FIG. 4a from below. In this variant, the electronic sensor 42 is placed, according to the “flip-chip” mounting technique, on a printed circuit 110 via the side of its active face 79 which includes the photosensitive surface 44. To this end, the printed circuit 110 fixed on a housing 111 of the camera includes openings 112, 114, 116, 118 for passage of the respective feet 62, 64, 66, 68 of the optics unit 46 in mechanical contact with the horizontal and vertical positioning surfaces of the electronic sensor. Electrical connections joining the electrical conductors of the active face (79) of the sensor to the electrical conductors of the printed circuit 110 are made by solder microbeads 120 according to the “flip-chip” technique for placing the sensor on the printed circuit.

FIG. 5 shows a perspective view of the optics unit 46 including the focusing lens 52. In the embodiments of the FIGS. 3a and 4a according to the invention, the optics unit 46 and the focusing lens 52 are molded in a single piece using transparent plastic. The optics unit is covered with a layer which is opaque to light, leaving the focusing lens 52 exposed. FIG. 5 shows the opacified surface of the optics unit, the lens having remained transparent to light. The precision of the molding is of the order of 1 micrometer, which is compatible with the positioning precision of the optics unit and of the sensor of the camera according to the invention.

In the corners of the electronic sensor, which is usually made of silicon, reference zones are arranged facing the vertical and horizontal surfaces of the feet of the optics unit. These reference zones are of the order of one millimeter square, and need not include electrical output areas. The only tolerance between the active part of the optics (output diopter) and that of the electronic sensor (photosensitive zone of the electronic sensor) is the geometrical tolerance of the optics unit.

The precisions obtained with this type of mounting are of the order of about ten micrometers. These tolerances are compatible with fixed, non-adjustable optics that have focal lengths of less than 5 millimeters.

Another advantage of the camera according to the invention resides in the fact that the dimensions of the optics unit are of the same order of magnitude as those of the image sensor made of silicon. This makes it possible to apply non-damaging forces to the silicon during assembly of the optics unit of image sensor.

The camera according to the invention, which is very small in size, provides focal depths of about 30 centimeters at infinity without any adjustment, which allows them to be integrated in electronic equipment such as microcomputers and portable telephones for which focusing adjustment of the camera is not desired.

1. An electronic camera for visualization of light images, including an electronic image sensor (12, 42) having an active face (79) including an arrangement of photosensitive pixels forming a photosensitive surface (16, 44), electrical conductors on the active face (79) and a free face (102) on the opposite side from the active face, an optics unit (22, 46) including at least one lens (14, 52) for focusing the light images on the photosensitive surface of the sensor, characterized in that the optics unit (52) is mechanically secured to the sensor (42) and in that, in order to provide centered focusing of the light images on the photosensitive surface (44) of the sensor, at least two positioning surfaces are in direct mechanical contact, one of the surfaces being on the optics unit and the other surface being on the sensor.

2. The electronic camera as claimed in claim 1, characterized in that the optics unit (46) and the electronic sensor (42) each include three mutually perpendicular plane surfaces, a plane surface of the optics unit (72, 74, 76, 78, 80a, 80b, 82a, 82b, 84a, 84b, 86a, 86b) being in contact with a respective parallel plane surface (79, 88, 90, 92, 94) of the electronic sensor, each pair of surfaces in contact canceling one of the three degrees of freedom of the optics unit with respect to the sensor at least in one of the two directions of each of the three axis of a reference trihedron Oxyz.

3. The electronic camera as claimed in one of claims 1 and 2, characterized in that the focusing lens (52) forms an integral part of the optics unit (46), making it directly secured to the sensor (42) by means of the optics unit and the positioning surfaces.

4. The electronic camera as claimed in one of claims 1 to 3, characterized in that the electronic sensor (42) is placed via its free face (102) on a printed circuit (100) including electrical conductors, electrical connection wires (106) joining the electrical conductors of the active face (79) to the electrical conductors of the printed circuit (100).

5. The electronic camera as claimed in one of claims 1 to 3, characterized in that the electronic sensor (42) is placed via its active face (79) on a printed circuit (110) including an opening for light to pass onto the photosensitive surface (44) of the sensor, the electrical connections joining the electrical conductors of the active face of the sensor to the electrical conductors of the printed circuit being made by solder microbeads (120).

6. The electronic camera as claimed in one of claims 1 to 5, characterized in that the optics unit (46), of cylindrical shape about an axis of revolution ZZ′, includes a first cylindrical wall (48) about the same axis ZZ′, the first cylindrical wall being closed in an upper part by a second wall (50) perpendicular to the axis ZZ′, the second wall (50) including at its center the lens (52) for focusing the images on the photosensitive surface of the electronic sensor (42).

7. The electronic camera as claimed in claim 6, characterized in that a lower part of the cylindrical wall includes passages (54, 56, 58, 60) leaving feet (62, 64, 66, 68) exposed for fastening the electronic sensor (42) onto the optics unit (46) on the same side as its photosensitive surface (44), each of the feet (62, 64, 66, 68) including:
a horizontal surface (72, 74, 76, 78), parallel to the plane Oxy, in direct mechanical contact with the active face (79) of the electronic electronic sensor (42) on the same side as the photosensitive surface (44), holding the focusing lens (50) in longitudinal position, along the axis ZZ′, with respect to the said photosensitive surface (44) of the sensor.
a pair of vertical surfaces (80a and 80b, 82a and 82b, 84a and 84b, 86a and 86b) which is parallel to the axis ZZ′, the vertical surfaces of one pair, which are mutually parallel and parallel to the horizontal surfaces (72, 74, 76, 78) of each of the feet, being in contact with vertical surfaces of the edges (88, 90, 92, 94) of the electronic sensor.

8. The electronic camera as claimed in one of claims 1 to 7, characterized in that the optics unit (46) and the focusing lens (52) are molded in a single piece using transparent plastic, the optics unit being covered with a layer which is opaque to light, leaving exposed the focusing lens (52) which is transparent to light.

9. The electronic camera as claimed in one of claims 1 to 8, characterized in that the optics unit (46) is held in position along the axis ZZ′, in direct contact with the electronic sensor (42), with the aid of a holding piece (108) secured to the printed circuit, the holding piece exerting a force for holding the optics unit against the electronic sensor.
